(19) United States
(12) Patent Application Publication
(10) Pub. No.: US 2009/0125357 A1
(43) Pub. Date: May 14, 2009

(54) Scheduling Procedure To Smooth The Flow of Air Traffic and Extend The Minimum Connect Time To a Greater Number of Passengers

(75) Inventors: Mark Bryan Vannette, Trophy Club, TX (US); Timothy Lee Jacobs, Grapevine, TX (US); Nurman Haripin, Plano, TX (US); Scott Kenneth Pool, Arlington, TX (US); Jeffrey Scott Warren, Euless, TX (US); Earl Kent Willoughby, Grapevine, TX (US); Hadi Waskito Pumomo, Coppell, TX (US); Phillippe Claude Quintard, Euless, TX (US); Ronald Paul Brensinger, North Richland Hills, TX (US); Steven John Iverson, Argyle, TX (US); Gautham Kundadke Kudva, Flower Mound, TX (US); Randolph James Essell, Arlington, TX (US); Ronald Wai Yin, Coppell, TX (US); Walter James Aue, Colleyville, TX (US)

Correspondence Address: WINSTEAD PC, P.O. BOX 50784, DALLAS, TX, 75201, US

(73) Assignee: American Airlines, Inc., DFW Airport, TX (US)

(21) Appl. No.: 11/937,172

(22) Filed: Nov. 8, 2007

(51) Int. Cl. G06Q 10/00

(52) U.S. Cl. 705/8

(57) ABSTRACT

A method for scheduling airplanes. Eastbound and westbound flights are scheduled to arrive to and depart from an airport within a small period of time (e.g., 5 minutes). By now scheduling both eastbound and westbound flights to arrive to and depart from an airport within a small block of time, the flow of air traffic is smoothed. Further, the scheduling structure of the present invention allows the passenger's connect time profile to be the same for all the passengers thereby extending the minimum connect time to a greater number of passengers. Further, the scheduling structure of the present invention allows staggered gating (gates are paired in such as a manner as to function as a single gate) thereby expanding gate separation as well as allowing a reduction or an elimination of the gap in times in the services being performed above and below the wings of an aircraft.

### TECHNICAL FIELD

The present invention relates to the field of airplane scheduling and ground crew management of aircrafts, and more particularly to scheduling first and second directional flights without a bank structure to arrive and depart within a small window of time (e.g., five minutes) thereby smoothing the flow of air traffic, extending the minimum connect time to a greater number of passengers, reducing the time an aircraft is parked at a gate, and minimizing the problem of having multiple aircraft desiring the use of a single gate.

### BACKGROUND INFORMATION

Typically, airplane schedules use directional banks. For example, airplanes can be scheduled such that eastbound flights and westbound flights arrive to and depart from an airport at alternating periods of time (e.g., 30 minutes). For instance, eastbound flights may be scheduled to arrive at the airport from 14:00 hours to 14:30 hours; whereas, westbound flights are scheduled to arrive at the airport between 15:30 hours and 16:00 hours. Similarly, eastbound flights may be scheduled to depart from the airport between 15:00 hours and 15:30 hours; whereas, westbound flight may be scheduled to depart from the airport between 16:30 and 17:00 hours. The alternating periods of time (e.g., 30 minutes) may be referred to herein as a “wave” of time or duration where the “wave” represents a bank or a collection of airplanes arriving to or departing from the airport during that period of time. An illustration of eastbound flights and westbound flights arriving to and departing from an airport at alternating periods of time of 30 minutes is provided in FIG. 1.

FIG. 1 illustrates eastbound flights arriving at the airport between 14:00 and 14:30 hours followed by westbound flights arriving at the airport between 15:30 and 16:00 hours and so forth. In this manner, a bank of eastbound flights and westbound flights land at alternating periods of time (e.g., 30 minutes).

Similarly, FIG. 1 illustrates eastbound flights departing at the airport between 15:00 and 15:30 hours followed by westbound flights departing at the airport between 16:30 and 17:00 hours and so forth. In this manner, a bank of eastbound flights and westbound flights depart at alternating periods of time (e.g., 30 minutes).

As a result of having a scheduling structure where waves of eastbound and westbound flights arrive and depart during certain blocks of time, the airport may experience peak operations at times and virtually no movement at other times. For example, as illustrated in FIG. 1, all the eastbound flights depart from 15:00 to 15:30 hours. There may be some westbound flights that are ready to depart during that time period; however, they can only depart during their designated period (16:30 to 17:00 hours). Hence, when that period of time occurs, there will be a collection of airplanes that could have left before that period of time but were held off to fly during that period of time because they were flying westward. As a result, there will be a huge collection of airplanes all scheduled to depart at the same time. This collection of airplanes is often referred to as a “peak” within the schedule. This results in operational inefficiency and a strain on airport operations. Hence, there is a need to smooth the flow of air traffic.

As further illustrated in FIG. 1, a percentage of the flights that land at the airport are what are referred to as “through flights.” Through flights may refer to arrival and departure flights having the same flight number. For example, suppose flight number 101 leaves Detroit and arrives in Dallas and then continues onto Austin. If the flight from Dallas to Austin has the same flight number, flight number 101, then the flight from Detroit to Dallas may be considered a “through flight” onto Austin. Through flights have marketing advantages in that passengers will prefer through flights over standard connecting itineraries. Further, through flights have operational advantages in that a certain percentage of the passengers and bags remain on board for the next leg of the trip thereby reducing the amount of work for the ground crew. Typically, these flights have ground times that vary depending on the aircraft type, such as 40 to 90 minutes for domestic departures and 90 minutes or more for international departures. For example, FIG. 1 illustrates through flights being on the ground approximately 60 minutes before departing to their destination, as indicated by “60” Acft G.T.” in FIG. 1.

A percentage of the eastbound flights that arrive at the airport depart westward instead of continuing eastward and vice-versa. Typically, these flights also have a ground time of approximately 60 minutes or more depending on the aircraft type.

Additionally, FIG. 1 illustrates that the connections from each flight are clustered in these 60 minute windows. For example, a passenger that arrives on the eastbound flight at 14:00 hours, and will be departing on a connecting eastbound flight, is scheduled to depart within the window of 15:00 to 15:30 hours thereby making that passenger's layover between 60 to 90 minutes. However, if a passenger arrives on the eastbound flight at 14:30 hours, and will also be departing on a connecting eastbound flight, then the connecting flight is scheduled to depart within the window of 15:00 to 15:30 hours thereby making that passenger's layover between 30 to 60 minutes. An illustration of having different connect time profiles is provided in FIG. 2.

Referring to FIG. 2, FIG. 2 illustrates that a passenger that arrives on the eastbound flight at 14:00 hours, and will be departing on a connecting eastbound flight, is scheduled to depart within the window of 15:00 to 15:30 hours thereby making that passenger's layover between 60 to 90 minutes (indicated by “60-90” Cnx” in FIG. 2). However, if a passenger arrives on the eastbound flight at 14:30 hours, and will also be departing on a connecting eastbound flight, then the connecting flight is scheduled to depart within the window of 15:00 to 15:30 hours thereby making that passenger's layover between 30 to 60 minutes (indicated by “30-60” Cnx”in FIG. 2). Hence, the 30 minute layover is the passenger's minimum connect time (MCT). However, the MCT is not available for all the passengers (e.g., those passengers arriving at 14:00 hours). The situation is similar for the passenger that arrives on a westbound flight and will be connecting to another westbound flight.

Hence, under this type of scheduling structure, not all arriving passengers have the possibility of connecting in the minimum connect time. By extending the minimum connect time to a greater number of passengers, a greater number of passengers may have a minimum layover.

Further, under this type of scheduling structure, a single ground crew is typically assigned to a single gate. The ground crew may be assigned the task of cabin cleaning as well as unloading and loading bags, freight and mail. FIG. 3 illustrates the services that are performed both above and below the wing of an airplane. Referring to FIG. 3, FIG. 3 illustrates that while the airplane is parked at a gate the following services and tasks are performed above the wing: opening of the aircraft door (indicated by “open a/c door”); deplaning the passengers (indicated by “deplane pax”); cabin cleaning (indicated by “cabin service”); boarding passengers (indicated by “boarding pax”) and having the passengers sit and closing the aircraft door (indicated by “sit/close door”). According to FIG. 3, the following services are performed below the wing while the airplane is parked at the gate: unloading of the bags after the parking brake has been set, the engine shut down and the wheels chocked (indicated by “engine stop”; “set up” and “unload bags”); unloading of the freight and mail (indicated by “unload freight/mail”); repositioning of the carts to load the freight, mail and bags (indicated by “reposition carts”); loading the freight and mail (indicated by “load freight/mail”); loading of the passengers' bags (indicated by “load bags”); cleaning the cargo (indicated by “cargo clear out”); and starting the engine (indicated by “engine start”). The total time to perform these services is approximately 41 minutes. As illustrated in FIG. 3, there is a gap in time between deplaning of the passengers and cleaning the cabin as well as a gap in time between unloading of the freight/mail and repositioning the carts. If these time gaps could be reduced or eliminated, then the time that an aircraft has to be parked at a gate could be reduced thereby allowing the aircraft to be flown in the air sooner.

Further, under this type of scheduling structure, there may be only a 15 minute gate separation as illustrated in FIGS. 4A-4B. Gate separation refers to the time allotted between the departure of an aircraft and the arrival of another aircraft at a particular gate. Referring to FIGS. 4A-4B, FIGS. 4A-4B illustrate the times of arrival and departure for airplanes at various gates (K1, K2, K3, K4, H10, H8 and H6) at an airport. FIGS. 4A-4B further illustrate in connection with the arrival and departure times, the flight numbers and airport codes for the flights to and from the airport. As illustrated in FIGS. 4A-4B, gate H5 is designated as a spare gate in case multiple planes desire to use a single gate. As further indicated in FIGS. 4A-4B, there are times when the duration of time for gate separation is extremely short, such as 15 minutes. By having such a small duration of time for gate separation, it is likely that an aircraft scheduled to arrive at a particular gate may find that an aircraft currently occupies that gate upon arrival and then has to wait until that aircraft leaves the assigned gate. This may occur if the aircraft arrives at the gate earlier than the scheduled time or if the aircraft occupying the gate leaves later than the scheduled time. While there is a spare gate to handle such a situation, this situation may occur when the spare gate is being used. If there was a greater gate separation, then the problem of having multiple aircraft desiring the use of a particular gate may be minimized. Further, if there was a greater gate separation, a spare gate may no longer be necessary thereby more efficiently using the gates.

Therefore, there is a need in the art to smooth the flow of air traffic to and from an airport; extend the minimum connect time to a greater number of passengers; reduce the time an aircraft is parked at a gate; and minimize the problem of having multiple aircraft desiring the use of a single gate to thereby reduce overall costs.

### SUMMARY

The problems outlined above may at least in part be solved in some embodiments by scheduling both eastbound and westbound flights to arrive to and depart from an airport within small periods of time (e.g., 5 minutes). By now scheduling both eastbound and westbound flights to arrive to and depart from an airport within a small block of time (e.g., five minutes), the flow of air traffic is smoothed. Further, the scheduling structure of the present invention allows the passenger's connect time profile to be the same for all the passengers thereby extending the minimum connect time to a greater number of passengers. Further, the scheduling structure of the present invention allows staggered gating (gates are paired in such as a manner as to function as a single gate) thereby expanding gate separation which minimizes the problem of having multiple aircraft desiring the use of a single gate. Additionally, staggered gating may reduce the time an aircraft is parked at a gate by allowing a reduction or an elimination of the gap in times in the services being performed above and below the wings of an aircraft.

In one embodiment of the present invention, a method for scheduling airplanes comprising the step of scheduling both first directional flights and second directional flights to arrive at an airport within a first duration of time. The method may further comprise scheduling both first and second directional flights to depart from the airport within a second duration of time, where the first and second duration of times are equal in length. By scheduling both first and second directional flights to arrive at the airport within the first duration of time and by scheduling both first and second directional flights to depart from the airport within the second duration of time, passengers of the first and second directional flights arriving at the airport have a same connect time profile.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates eastbound and westbound flights arriving and departing in alternating periods of 30 minutes;

FIG. 2 illustrates passengers having different connect time profiles when eastbound and westbound flights arrive and depart in alternating periods of 30 minutes;

FIG. 3 illustrates the services performed above and below the wing of an airplane;

FIGS. 4A-4B illustrate the scheduled times airplanes arrive and depart from various gates at an airport thereby indicating the gate separation at the various gates;

FIG. 5 is a flowchart of a method for scheduling airplanes in accordance with an embodiment of the present invention;

FIG. 6 illustrates scheduling both eastbound and westbound flights to arrive to and depart from an airport within a small period of time in accordance with an embodiment of the present invention;

FIG. 7 illustrates passengers having the same connect time profiles under the scheduling structure of the present invention in accordance with an embodiment of the present invention;

FIGS. 8A-8B illustrate expanding gate separation to approximately 30 minutes using what is referred to herein as “checkerboard gating” in accordance with an embodiment of the present invention; and

FIG. 9 illustrates the elimination of the gaps of time between deplaning of the passengers and cleaning the cabin as well as between unloading of the freight/mail and repositioning of the carts in accordance with an embodiment of the present invention.

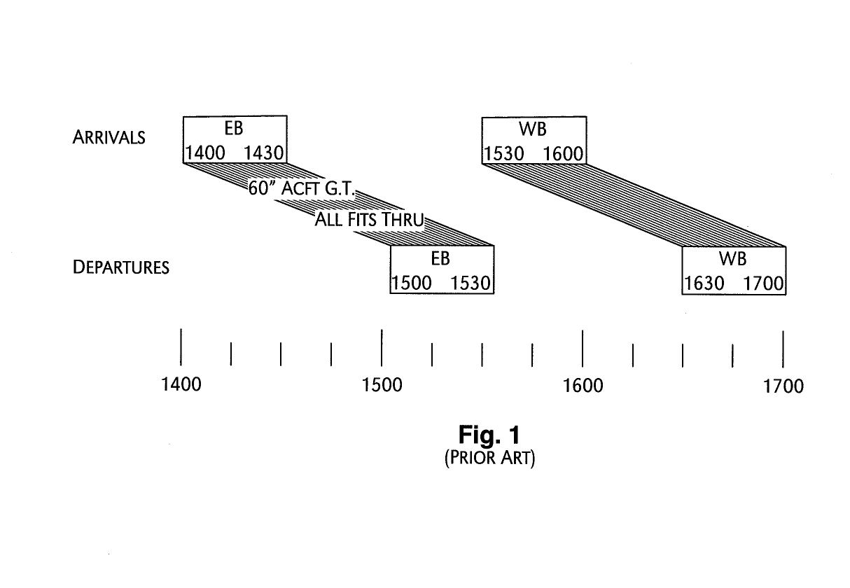

### DETAILED DESCRIPTION

The present invention comprises a method for scheduling airplanes. In one embodiment of the present invention, both eastbound and westbound flights are scheduled to arrive to and depart from an airport within a small period of time (e.g., 5 minutes). By now scheduling both eastbound and westbound flights to arrive to and depart from an airport within a small block of time (e.g., five minutes), the flow of air traffic is smoothed. Further, the scheduling structure of the present invention allows the passenger's connect time profile to be the same for all the passengers thereby extending the minimum connect time to a greater number of passengers. Further, the scheduling structure of the present invention allows staggered gating (gates are paired in such as a manner as to function as a single gate) thereby expanding gate separation which minimizes the problem of having multiple aircraft desiring the use of a single gate. Additionally, staggered gating may reduce the time an aircraft is parked at a gate by allowing a reduction or an elimination of the gap in times in the services being performed above and below the wings of an aircraft.

Even though the following discusses the present invention in connection with eastbound and westbound flights, the principles of the present invention may be applied to other directional flights, such as northbound and southbound. A person of ordinary skill in the art would be capable of applying the principles of the present invention to such other directional flights. Further, embodiments covering such other directional flights would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

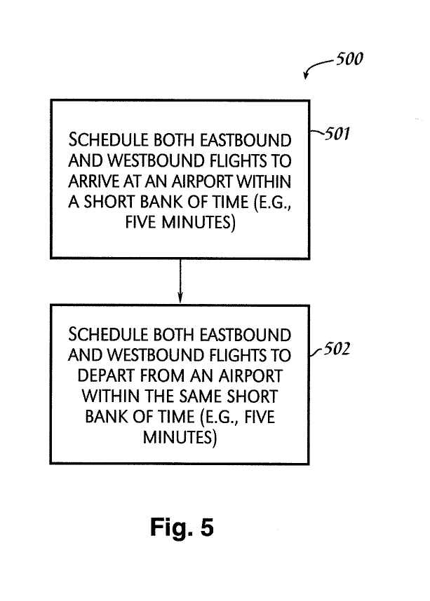

As stated in the Background Information section, under the current scheduling structure, there will be a significant collection of airplanes arriving or departing at nearly the same time thereby putting a strain on airport operations and resources. Hence, there is a need to smooth the flow of air traffic. Further, under the current scheduling structure, not all arriving passengers have the possibility of having a minimum connect time. By extending the minimum connect time to a greater number of passengers, a greater number of connecting passengers may have a minimum layover. Further, under the current scheduling structure, there is a gap in time between deplaning of the passengers and cleaning the cabin as well as a gap in time between unloading of the freight/mail and repositioning of the carts. If these time gaps could be reduced or eliminated, then the time that an aircraft has to be parked at a gate could be reduced thereby allowing the aircraft to be flown in the air sooner. Further, if there was a greater gate separation under the current scheduling structure, then the problem of having multiple aircraft desiring the use of a particular gate may be minimized. Further, if there was a greater gate separation, a spare gate may no longer be necessary thereby more efficiently using the gates. Therefore, there is a need in the art to smooth the flow of air traffic to and from an airport; extend the minimum connect time to a greater number of passengers; reduce the time an aircraft is parked at a gate; and minimize the problem of having multiple aircraft desiring the use of a single gate. The air traffic may be smoothed, the minimum connect time may be extended to a greater number of passengers, the time an aircraft is parked at a gate may be reduced, and the problem of having multiple aircraft desiring the use of a single gate may be minimized using a new scheduling structure as discussed below in associated with FIGS. 5-9.

FIG. 5 is a flowchart of a method 500 for implementing a new scheduling structure that smoothes the flow of air traffic, extends the minimum connect time to a greater number of passengers, reduces the time an aircraft is parked at a gate and minimizes the problem of having multiple aircraft desiring the use of a single gate in accordance with an embodiment of the present invention.

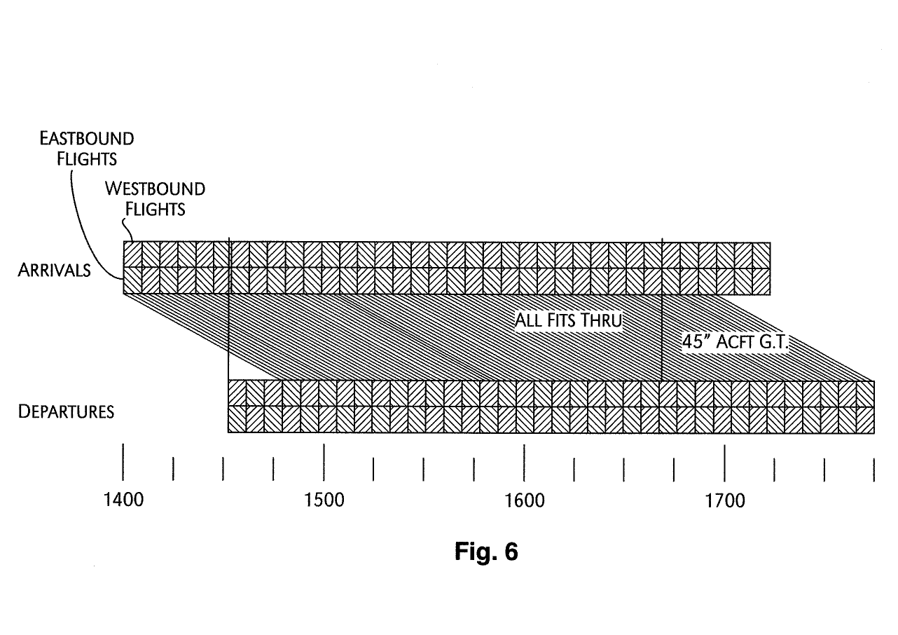

Referring to FIG. 5, in step 501, the eastbound and westbound flights are scheduled to arrive at an airport within a short duration of time (e.g., five minutes) as illustrated in FIG. 6. FIG. 6 illustrates the new scheduling structure that smoothes the flow of air traffic to and from an airport by scheduling eastbound and westbound flights to arrive to and depart from an airport within a small window of time (e.g., five minutes) in accordance with an embodiment of the present invention. In one embodiment, the small window of time may be between approximately five minutes and fifteen minutes. Referring to FIG. 6, a collection of eastbound flights and a collection of westbound flights are scheduled to both arrive within a short duration of time (e.g., five minutes). The eastbound flights are indicated by the darker shade and the westbound flights are indicated by the lighter shade. By scheduling eastbound and westbound flights in this interleaved fashion, the structural “directionality” is removed. That is, no longer are eastbound and westbound flights scheduled to arrive separately in alternating blocks of time.

Returning to FIG. 5, in step 502, the eastbound and westbound flights are scheduled to depart from the airport within the same short duration of time (e.g., five minutes) as illustrated in FIG. 6. Referring to FIG. 6, FIG. 6 illustrates that the eastbound flights and the westbound flights depart approximately 45 minutes after arriving (indicated by “45” Acft G.T.” in FIG. 6) within the same block of time (e.g., five minutes). Some of the eastbound flights that arrived will depart westward; while, other eastbound flights will depart eastwardly. Similarly, some of the westbound flights that arrive will depart eastwardly; while, other westbound flights will depart westward. A mixture of these eastbound and westbound flight departures occur within the same bank of time (e.g., five minutes). By scheduling arrivals and departures for both eastbound and westbound flights in this interleaved fashion, a huge collection of airplanes should not now want to arrive or depart at the same time. As a result, airport operational efficiency is improved and the flow of air traffic is smoother.

As further illustrated in FIG. 6, a percentage of the flights that land at the airport are “through flights.” Typically, through flights are on the ground for approximately 45 minutes before departing to their destination (indicated by “45” Acft G.T.” in FIG. 6). The through flights are indicated by the lines extending from the bank of arrival flights to the bank of departure flights.

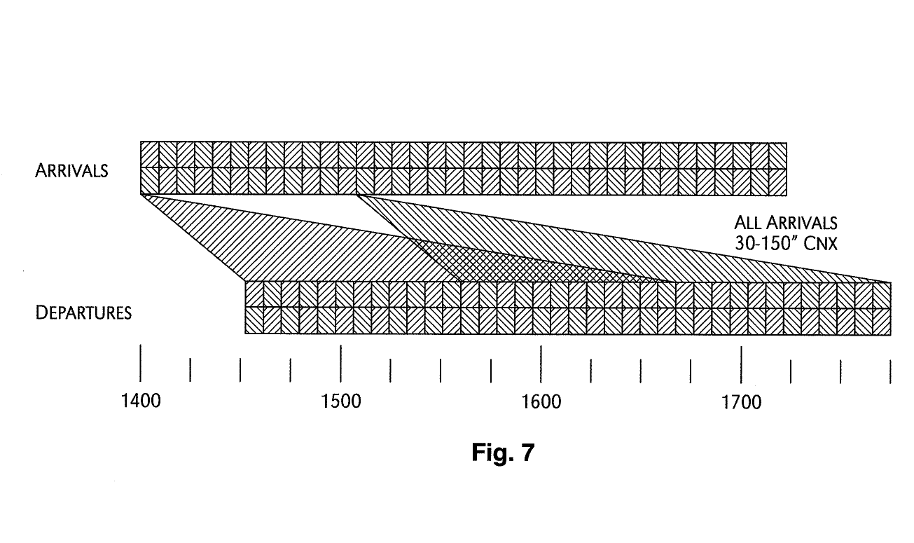

As a result of having a scheduling structure that schedules eastbound and westbound flights to arrive to and depart from an airport in a small bank of time (e.g., five minutes), the passenger's connect time profile is the same for all the passengers thereby extending the minimum connect time to a greater number of passengers as illustrated in FIG. 7.

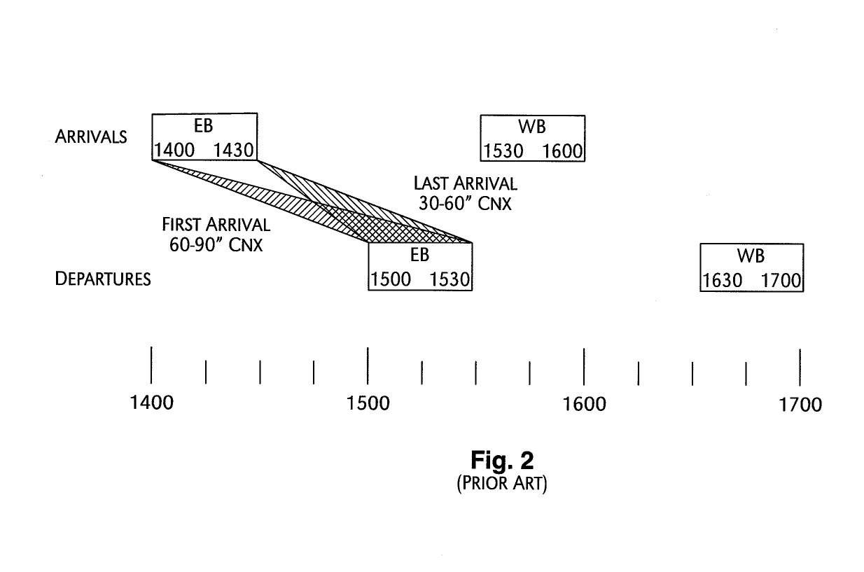

FIG. 7 illustrates extending the minimum connect time to a greater number of passengers as a result of implementing the new scheduling structure in accordance with an embodiment of the present invention. Referring to FIG. 7, each passenger has a connection time between 30 to 150 minutes (indicated by “30-150” Cnx” in FIG. 7). For example, a passenger that arrived at 14:00 has a possible connection time between 14:30 and 16:30. Further, a passenger that arrived at 15:00 has a possible connection time between 15:30 and 17:30. Hence, each passenger has the opportunity to have a minimum connect time (30 minutes); whereas, as illustrated in FIG. 2, under the current scheduling structure, not every passenger had the opportunity to have a minimum connect time. Some of those passengers under the current scheduling structure had a connect time between 60 to 90 minutes. By implementing the scheduling structure of the present invention, the minimum connect time is extended to a greater number of passengers thereby allowing a greater number of passengers to have a minimum layover. It is noted that while FIG. 7 illustrates a minimum connect time of approximately 30 minutes that the minimum connect time may usually be between approximately 30 to 40 minutes.

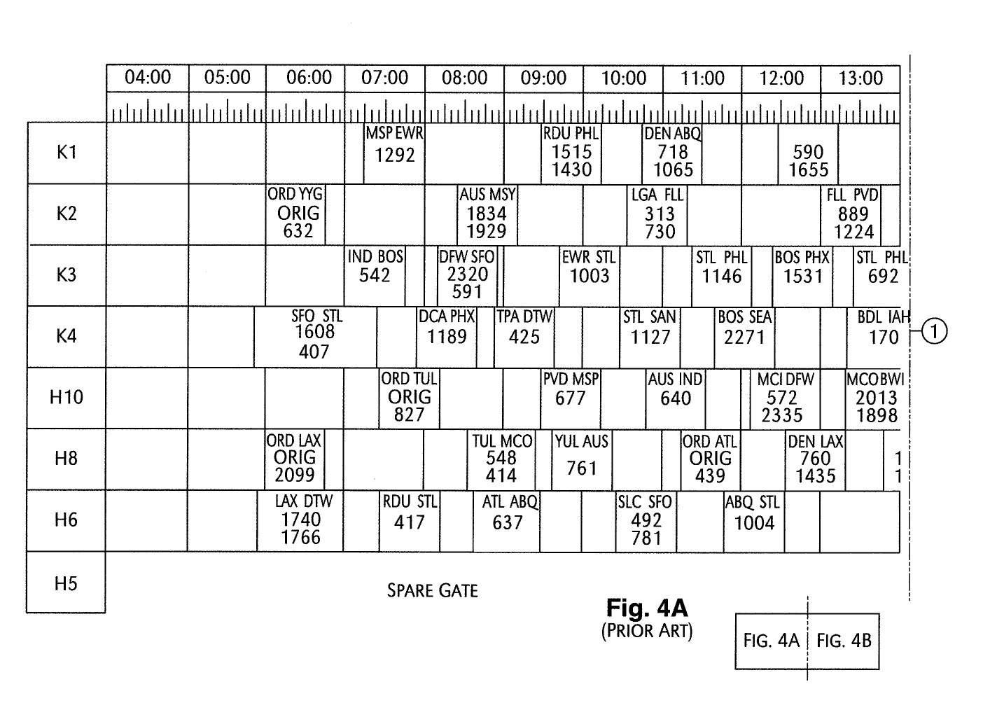

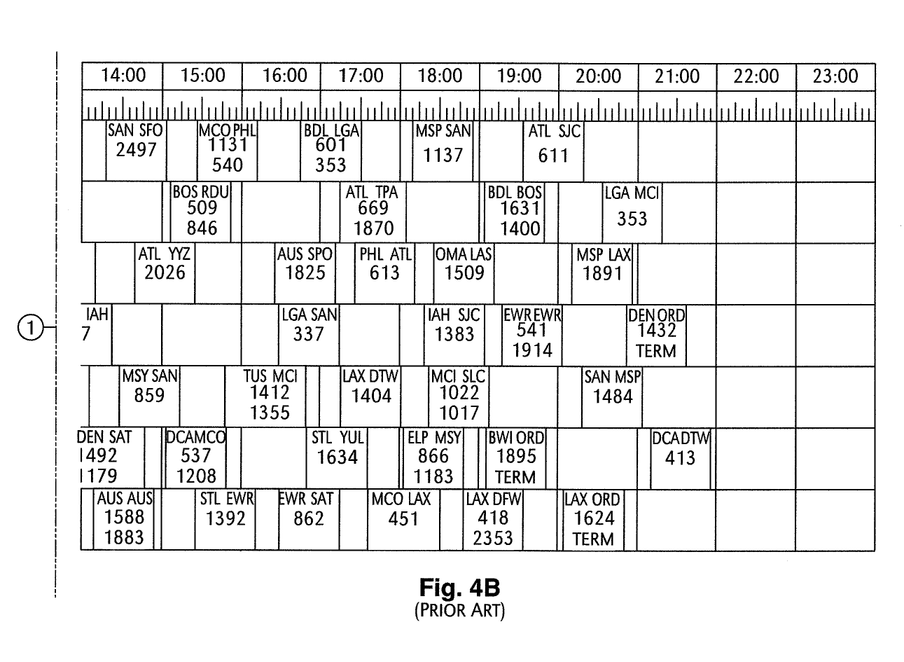

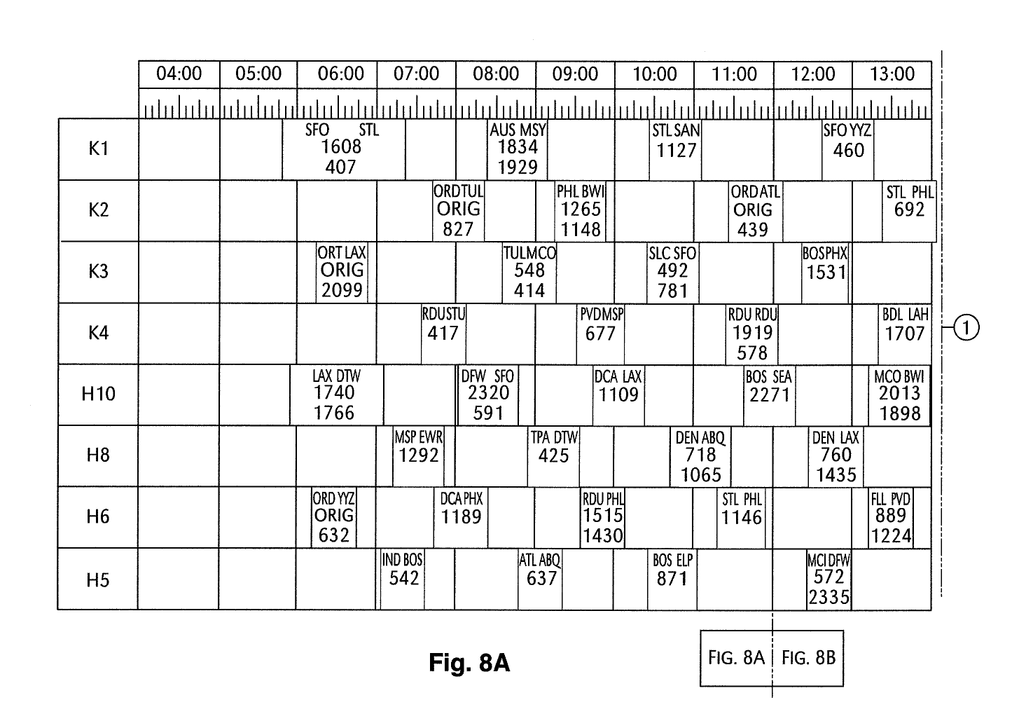

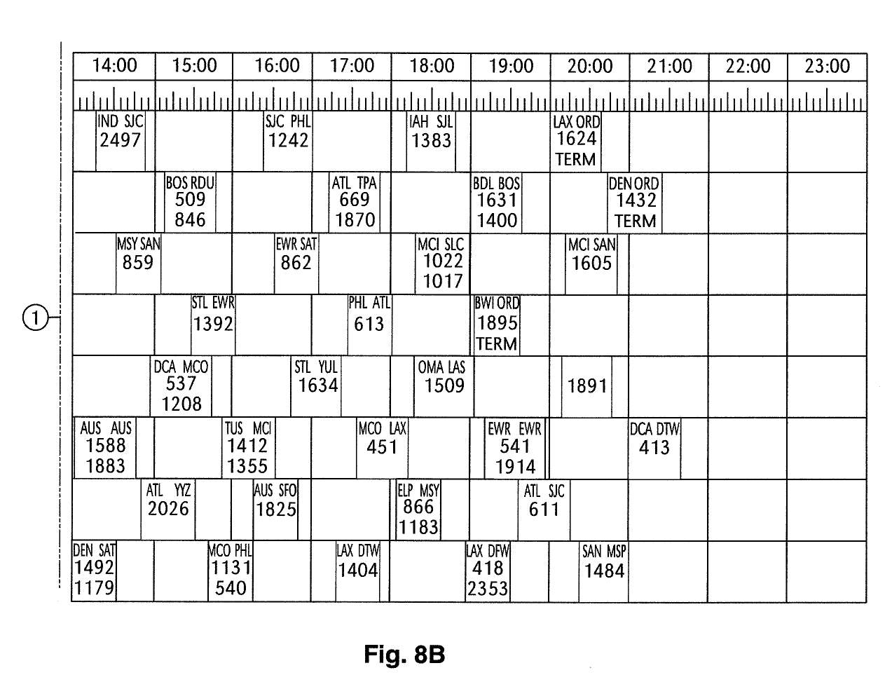

In addition to extending the minimum connect time to a greater number of passengers, the scheduling structure of the present invention allows staggered gating referred to herein as “checkerboard gating” as illustrated in FIGS. 8A-8B. FIGS. 8A-8B illustrate expanding the gate separation using “checkerboard gating” in accordance with an embodiment of the present invention. Referring to FIGS. 8A-8B, FIGS. 8A-8B illustrate the times of arrival and departure for airplanes at various gates (K1, K2, K3, K4, H10, H8, H6 and H5) at an airport. FIGS. 8A-8B further illustrate in connection with the arrival and departure times, the flight numbers and airport codes for the flights to and from the airport. By implementing the scheduling structure of the present invention, the gates (K1, K2, K3, K4, H10, H8, H6 and H5) are paired in such a fashion as to function as a single gate so that airplanes should be parked at the paired gates at different times. For example, gates K1 and K2 are paired off. When airplanes are parked at gate K1, no airplanes are parked at gate K2 and vice-versa. Other pairs of gates include gates K3 and K4; gates H10 and H8; and gates H6 and H5. Pairing gates in such a fashion is referred to as checkerboard gating. By implementing checkerboard gating, the gate separation may be expanded from 15 minutes (gate separation using the current scheduling structure is approximately 15 minutes as illustrated in FIGS. 4A-4B) to approximately 30 minutes. By expanding the gate separation, the problem of having multiple desiring the use of a particular gate is reduced. Further, by implementing checkerboard gating, a spare gate is no longer necessary (gate H5 was a spare gate using the current scheduling structure as illustrated in FIGS. 4A-4B). Instead, the spare gate may be used as a regular gate thereby more efficiently using the gates at the airport.

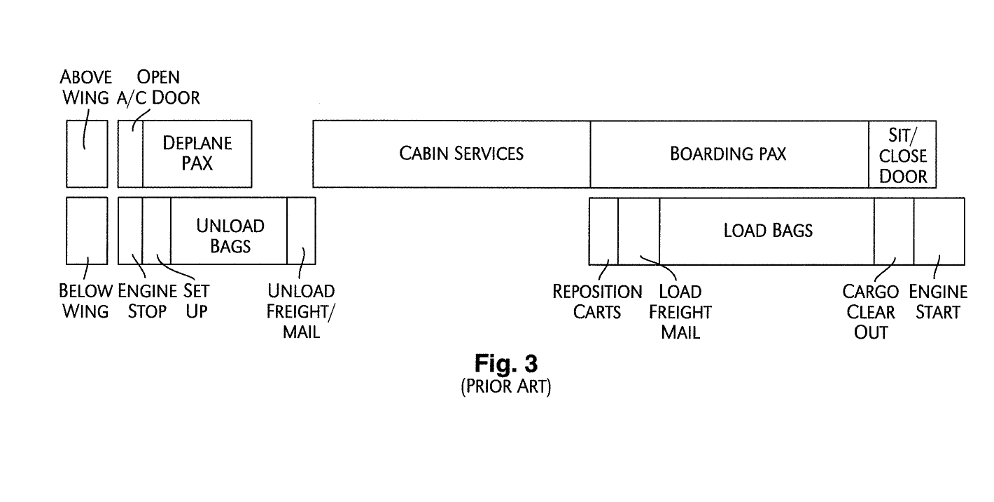

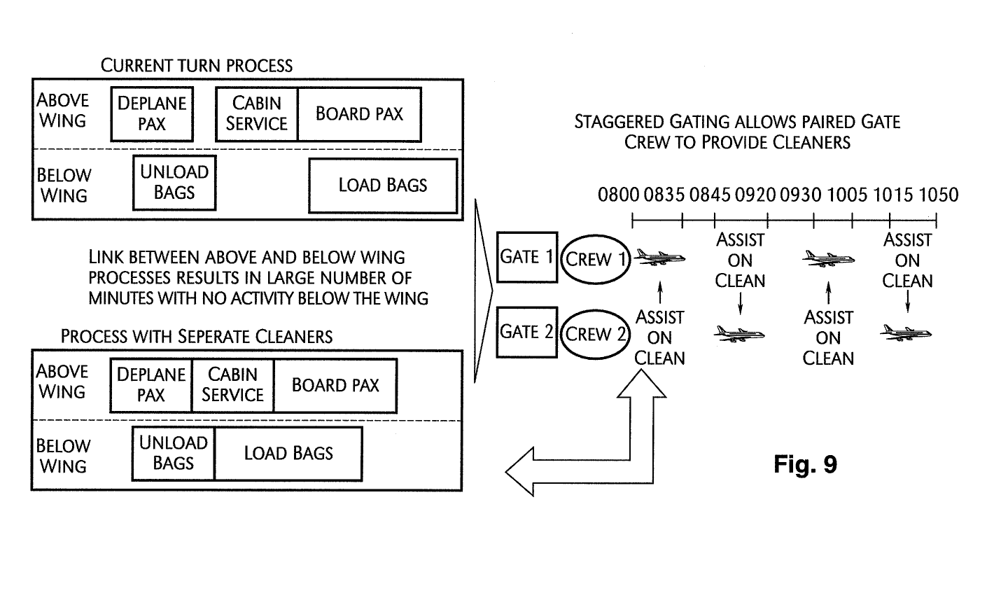

Further, by implementing checkerboard gating, a single ground crew may now be assigned to the pair of gates discussed above instead of a single gate as illustrated in FIG. 9. FIG. 9 illustrates reducing the time an aircraft is parked at a gate as a result of implementing the new scheduling structure in accordance with an embodiment of the present invention. Referring to FIGS. 3 and 9, as stated in the Background Information section, under the current scheduling structure, there is a gap in time between deplaning of the passengers and cleaning the cabin as well as a gap in time between unloading of the freight/mail and repositioning of the carts. By having these gaps in time as illustrated in FIG. 3 and the top left portion of FIG. 9, the total time to perform the services above and below the wing of an airplane is approximately 41 minutes.

However, by implementing checkerboard gating, the gap in time between deplaning of the passengers and cleaning the cabin as well as a gap in time between unloading of the freight/mail and repositioning of the carts can be reduced or eliminated. Since airplanes are parked at a particular pair of gates in a staggered manner, the ground crew assigned to that pair of gates will be able to perform the service of cleaning the cabin after deplaning of the passengers without any gap in time as illustrated in the right portion of FIG. 9. The right portion of FIG. 9 illustrates a single ground crew assigned to gates 1 and 2. While the airplane is parked at gate 1, there is not an airplane parked at gate 2 and vice-versa. Hence, while the airplane is parked at gate 1 (e.g., 08:00-08:35), the ground crew is able to perform cleaning services on that airplane since they do not have to service an airplane at gate 2. When an airplane is parked at gate 2 (e.g., 08:45-09:20), the same ground crew is able to perform cleaning services on that airplane since an airplane does not need to be serviced at gate 1. Hence, by implementing checkerboard gating, the ground crew assigned to a pair of gates is able to perform the cleaning services on airplanes that arrive at each of the pair of gates as well as being able to perform the cleaning services after the deplaning of the passengers without any gap in time.

Further, due to checkerboard gating, the ground crew assigned to a pair of gates will be able to perform the service of repositioning of the carts and loading freight/mail/bags following the unloading of the bags without any gap in time. The ground crew is able to perform such a service since there is not an airplane that needs to be serviced at the other paired gate. By reducing or eliminating the gaps in time between deplaning of the passengers and cleaning the cabin as well as between the unloading of the freight/mail and repositioning of the carts, the total time to perform the services above and below the wing of an airplane will be reduced to approximately 35 minutes from 41 minutes as illustrated in the left bottom portion of FIG. 9. By reducing or eliminating these gaps in time, the time the aircraft is parked at a gate is reduced thereby allowing the aircraft to be flown in the air sooner.

It is noted that method 500 may include other and/or additional steps that, for clarity, are not depicted. It is further noted that method 500 may be executed in a different order presented and that the order presented in the discussion of FIG. 5 is illustrative. It is further noted that certain steps in method 500 may be executed in a substantially simultaneous manner.

Although the method is described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1. A method for scheduling airplanes comprising the steps of:
scheduling both first directional flights and second directional flights to arrive at an airport within a first duration of time; and
scheduling both said first and second directional flights to depart from said airport within a second duration of time, wherein said first and second duration of times are equal in length;
wherein by scheduling both said first and second directional flights to arrive at said airport within said first duration of time and by scheduling both said first and second directional flights to depart from said airport within said second duration of time, passengers of said first and second directional flights arriving at said airport have a same connect time profile.

2. The method as recited in claim 1, wherein said first and second duration of times are between approximately five and fifteen minutes.

3. The method as recited in claim 1, wherein said connect time profile includes a minimum connection time.

4. The method as recited in claim 3, wherein said connect time profile is a connection spread across 30 to 150 minutes.

5. The method as recited in claim 3, wherein said minimum connection time is between approximately 30 to 40 minutes.

6. The method as recited in claim 1, wherein by scheduling both said first and second directional flights to arrive at said airport within said first duration of time and by scheduling both said first and second directional flights to depart from said airport within said second duration of time, airplanes are scheduled to arrive at a gate approximately 30 minutes apart from one another.

7. The method as recited in claim 1, wherein by scheduling both said first and second directional flights to arrive at said airport within said first duration of time and by scheduling both said first and second directional flights to depart from said airport within said second duration of time, a single ground crew is assigned to two gates.

8. The method as recited in claim 7, wherein by having a single crew assigned to two gates, a gap in time between deplaning passengers and cleaning a cabin of an aircraft is reduced, wherein by having a single crew assigned to two gates, a gap in time between unloading freight and mail and repositioning carts is reduced.

9. The method as recited in claim 1, wherein by scheduling both said first and second directional flights to arrive at said airport within said first duration of time and by scheduling both said first and second directional flights to depart from said airport within said second duration of time, a pair of gates function as a single gate thereby allowing airplanes to be parked at one of said pair of gates at a different time than airplanes parked at the other of said pair of gates.

10. The method as recited in claim 9, wherein by allowing said pair of gates to function as said single gate, an aircraft is parked at a gate for approximately 35 minutes.

11. The method as recited in claim 1, wherein said first directional flights corresponds to eastbound flights, wherein said second directional flights correspond to westbound flights.

12. The method as recited in claim 1, wherein said first directional flights corresponds to northbound flights, wherein said second directional flights correspond to southbound flights.
